(19) United States
(12) Patent Application Publication
(10) Pub. No.: US 2013/0040523 A1
(43) Pub. Date: Feb. 14, 2013

(54) PROTECTIVE SUIT FABRIC AND SPUN YARN USED FOR THE SAME

(71) Applicants: Masanobu Takahashi, Aichi (JP); Hideki Omori, Hyogo (JP)

(72) Inventors: Masanobu Takahashi, Aichi (JP); Hideki Omori, Hyogo (JP)

(73) Assignees: SABIC INNOVATIVE PLASTICS IP B.V., Bergen op Zoom (NL); THE JAPAN WOOL TEXTILE CO., LTD., Kobe-shi, Hyogo (JP)

(21) Appl. No.: 13/695,708

(22) PCT Filed: Feb. 27, 2012
(86) PCT No.: PCT/JP2012/054795

§ 371 Date: Nov. 1, 2012

(30) Foreign Application Priority Data
Apr. 1, 2011 (JP) 2011-081862

(51) Int. Cl. B32B 5/16; D04B 1/16; D02G 3/36; D03D 25/00

(52) U.S. Cl. 442/190; 428/221; 442/309; 428/373

(57) ABSTRACT

A protective suit fabric of the present invention is a heat-resistant flame-retardant protective suit fabric, which is formed of a spun yarn. The fiber blend rate is: 25-75 mass % of polyetherimide fiber (A); 20-50 mass % of at least one fiber (B) selected from wool and flame-retardant rayon; and 5 to 25 mass % of para-aramid fiber (C). The spun yarn for forming the fabric is a two-fold yarn (20) prepared by twisting: 1) a single yarn (24) of a uniform blended spun yarn including the fiber components (A) and (B); and 2) a single yarn (23) of a sheath-core spun yarn including a core (21) of stretch-broken spun yarn of the para-aramid fiber (C) and a sheath (22) formed by blend-spinning the polyetherimide fiber (A) and the at least one fiber (B) selected from wool and flame-retardant rayon. The protective suit fabric has high washing resistance. The protective suit fabric provides favorable comfort in wearing even if the suit is worn in the hot seasons or even if the wearer perspires during exertion. The fabric has high heat resistance and high flame retardance, favorable dye affinity, and the fabric can be produced at a low cost. Also a spun yarn used for the fabric is provided.

### TECHNICAL FIELD

The present invention relates to a protective suit fabric and a spun yarn used for the same.

### BACKGROUND ART

Protective suits have been used widely, for example as work clothing worn by fire fighters, ambulance crews, rescue workers, maritime lifeguards, military, workers at oil-related facilities, and workers at chemical facilities. A para-aramid fiber is used in general for such a protective suit fabric that is required to have heat resistance and flame retardance. However, the para-aramid fiber is problematic in that it is expensive and poorly dyed. In order to cope with the problem, the inventors proposed a sheath-core spun yarn having a core of stretch-broken spun yarn of a para-aramid fiber and a sheath of a meta-aramid fiber, a flame-retardant acrylic fiber or a polyetherimide fiber (Patent document 1). A blended spun article of a heat-resistant fiber such as para-aramid fiber and a carbonizable flame-retardant fiber such as flame-retardant rayon or flame-retardant vinylon is proposed in Patent document 2.

However, since the content of the para-aramid fiber in the fiber composition as proposed in Patent document 1 is high, the cost is raised. Regarding the fiber compositions as proposed by Patent document 2, which is simply blended and spun, the para-aramid fiber exposed on the surface will be fibrillated easily due to abrasion or the like at the time of washing. This causes a whitening phenomenon for the fabric surface, resulting in significantly poor appearance.

### PRIOR ART DOCUMENTS

### Patent Documents

Patent document 1: WO 2009/014007
Patent document 2: JP 2008-101294

### DISCLOSURE OF INVENTION

### Problem to be Solved by the Invention

For solving the above-mentioned problems, the present invention provides a protective suit fabric having high washing resistance. The protective suit fabric provides favorable comfort in wearing even if the suit is worn in the hot seasons or even if the wearer perspires during exertion. The fabric has high heat resistance and high flame retardance, and favorable dye affinity, and the fabric can be produced at a low cost. The present invention also provides a spun yarn used for the fabric.

### Means for Solving Problem

A protective suit fabric of the present invention is a heat-resistant flame-retardant protective suit fabric formed of a spun yarn of fibers blended at a blend rate: 25 to 75 mass % of polyetherimide fiber (A); 20 to 50 mass % of at least one fiber (B) selected from wool and flame-retardant rayon; and 5 to 25 mass % of para-aramid fiber (C) when the fabric is formed of 100 mass % of fibers. The spun yarn for forming the fabric is a two-fold yarn prepared by twisting 1) a single yarn of a uniform blended spun yarn including the fiber components (A) and (B); and 2) a single yarn of a sheath-core spun yarn including a core of a yarn of a stretch-broken spun para-aramid fiber (C) and a sheath formed by blend-spinning the polyetherimide fiber (A) and the at least one fiber (B) selected from wool and flame-retardant rayon.

A spun yarn of the present invention is a spun yarn to be used for the above-mentioned protective suit fabric. It is a two-fold yarn prepared by twisting: 1) a single yarn of a uniform blended spun yarn including the fiber components (A) and (B); and 2) a single yarn of a sheath-core spun yarn including a core of a yarn of a stretch-broken spun para-aramid fiber (C) and a sheath formed by blend-spinning the polyetherimide fiber (A) and the at least one fiber (B) selected from wool and flame-retardant rayon.

### Effects of the Invention

Since the protective suit fabric of the present invention has high washing resistance, fibrillation is suppressed and thus the appearance will not deteriorate even after a repeated washing. Even when being exposed to high-temperature heat flux, the fabric is not shrunk by heat, and is less carbonized. The comfort in wearing is favorable even if the suit is worn in the hot seasons or even if the wearer perspires during exertion. And the fabric can be produced at a low cost. The spun yarn of the present invention prepared by concentrating the para-aramid fiber at only the core part has high heat resistance and high flame retardance, favorable dye affinity and the production cost can be reduced.

### BRIEF DESCRIPTION OF DRAWINGS

FIG. 1 is a perspective view showing main elements of a ring frame for producing a sheath-core structured spun yarn according to an example of the present invention.

FIG. 2 is a schematic cross-sectional view showing a two-fold yarn according to an example of the present invention.

### DESCRIPTION OF THE INVENTION

An object of the present invention is to decrease the rate of expensive para-aramid fiber and to suppress fibrillation at the time of washing so as to prevent a problem of poor appearance. For achieving the object, a single yarn of a sheath-core spun yarn including a para-aramid fiber concentrated at only the core part and a single yarn of a uniform blended spun yarn that does not include the para-aramid fiber at all are used to develop work clothing.

The protective suit fabric formed of the following two kinds of spun yarns of the present invention includes: 25 to 75 mass % of polyetherimide fiber (A); 20 to 50 mass % of at least one fiber (B) selected from wool and flame-retardant rayon; and 5 to 25 mass % of para-aramid fiber (C). It is preferable that the fabric includes: 40 to 70 mass % of polyetherimide fiber (A); 25 to 40 mass % of at least one fiber (B) selected from wool and flame-retardant rayon; and 5 to 25 mass % of para-aramid fiber (C).

The spun yarn is a two-fold yarn prepared by twisting 1) a single yarn of a uniform blended spun yarn including the fiber components (A) and (B); and 2) a single yarn of a sheath-core spun yarn including a core of a yarn of a stretch-broken spun para-aramid fiber (C) and a sheath formed by blend-spinning the polyetherimide fiber (A) and the at least one fiber (B) selected from wool and flame-retardant rayon. The two-fold yarn is made into a woven fabric or a knitted fabric. Hereinafter, in the description, the “sheath fiber” is referred to as also “covering fiber”.

1. Applied Fiber

Hereinafter, the respective fibers will be described.

### (1) Polyetherimide Fiber

An example of the polyetherimide fiber is “Ultem” manufactured by Sabic Innovative Plastics (limiting oxygen index (LOI): 32). This fiber has a tensile strength of about 3 cN/decitex. It is preferable that the polyetherimide single fiber has a fineness of not more than 3.9 decitex (3.5 deniers) and more preferably not more than 2.8 decitex (2.5 deniers). When the fineness is not more than 3.9 decitex (3.5 deniers), the fiber has flexibility and preferable feeling, and it can be applied suitably to work clothing. A preferable average fiber length of the polyetherimide fiber is in a range of 30 to 220 mm, and more preferably, in a range of 80 to 120 mm, and particularly preferably in a range of 90 to 110 mm. The polyetherimide fiber having the fiber length in this range can be spun easily.

(2) Wool

Commonly-used merino wool or the like can be used. The wool can be used in a natural state. Alternatively, wool that has been dyed as a fiber (hereinafter, it is referred to as yarn-dyed product) can be used. It is preferable that a yarn-dyed product is used. For the wool, unmodified wool may be used. Alternatively, wool that has been modified by for example removing the surface scales for shrink proofing may be used. Such an unmodified or modified wool is used to improve hygroscopicity and to shield radiant heat so that the comfort in wearing is kept favorable despite wetting from sweat during exertion under a high-temperature and severe environment, thereby exhibiting heat resistance for protecting the human body. The above-mentioned effect can be obtained also by using wool that has been subjected to a ZIRPRO process (a process with titanium and zirconium salt). This process developed by the International Wool Standard Secretariat is well known as a process for providing flame retardance to wool.

(3) Flame-Retardant Rayon

Examples of flame-retardant rayon include a rayon that has been subjected to a PROBAN process (an ammonium curing process using tetrakis hydroxymethyl phosphonium salt developed by Albright & Wilson Ltd.), a rayon that has been subjected to a Pyrovatex CP process (process with N-methylol dimethylphosphonopropionamide) developed by Ciba-Geigy, and “Viscose FR (trade name) manufactured by Lenzing AG in Austria.

(4) Para-Aramid Fiber

Examples of aramid fibers include a para-aramid fiber and a meta-aramid fiber. In the present invention, the para-aramid fiber is used. The para-aramid fiber has high tensile strength (for example, “Technora” manufactured by Teijin, Ltd., 24.7 cN/decitex; “Kevlar” manufactured by DuPont, 20.3 to 24.7 cN/decitex). In addition, the thermal decomposition starting temperature is high (about 500° C. for both of the above products) and the limiting oxygen index (LOI) is in a range of 25-29, and thus the products can be used preferably for a heat-resistant fabric and heat-resistant protective suits. It is preferable that the single fiber fineness of the para-aramid fiber is in a range of 0.5 to 6 deci tex, and more preferably, in a range of 1 to 4 deci tex.

2. Blend Rates of Respective Fibers

The protective suit fabric of the present invention is formed of a two-fold yarn prepared by twisting a single yarn of a uniform blended spun yarn and a single yarn of a sheath-core spun yarn, and the two-fold yarn includes: 25 to 75 mass % of polyetherimide fiber, 20 to 50 mass % of at least one fiber selected from wool and flame-retardant rayon, and 5 to 25 mass % of para-aramid fiber.

More preferably, the blend rate is: 40 to 70 mass % of polyetherimide fiber, 25 to 40 mass % of at least one fiber selected from wool and flame-retardant rayon, and 5 to 20 mass % of para-aramid fiber. When the fiber contents are in the above-mentioned ranges, the comfort in wearing is favorable, the heat resistance and flame retardance are high, the dye affinity is favorable, and the production cost can be reduced. When the content of the para-aramid fiber is less than the range, heat shrinkage at high temperature is increased, and it is not preferable. When the content of the para-aramid fiber exceeds the range, the cost is raised. When the content of the polyetherimide fiber is less than the range, the dye affinity deteriorates. When the content of the polyetherimide fiber exceeds the range, the heat shrinkage at high temperature is increased, and it is not preferable. When the content of the at least one fiber selected from wool and flame-retardant rayon is less than the range, the comfort in wearing deteriorates, and it is not preferable. When the content of the at least one fiber selected from wool and flame-retardant rayon exceeds the above-mentioned range, the heat resistance and flame retardance deteriorate, and it is not preferable.

More preferably, the uniform blended spun yarn includes 40 to 69 mass % of polyetherimide fiber, 25 to 40 mass % of at least one fiber selected from wool and flame-retardant rayon, 5 to 20 mass % of para-aramid fiber, and 0.1 to 1 mass % of antistatic fiber. When the contents are in these ranges, antistatic effects will be provided in addition to the above mentioned effects.

3. Uniform Blended Spun Yarn

For making a uniform blended spun yarn, according to a usual spinning method, the fibers are blended in steps such as carding, roving, drafting or any other preceding steps so as to manufacture a spun yarn.

4. Sheath-Core Spun Yarn

(1) Stretch-Break Spinning

The core is a stretch-broken spun para-aramid fiber yarn. Here, a stretch-broken spun yarn indicates a yarn prepared by drafting and cutting a filament bundle (tow), and twisting. The spinning may be a direct spinning to perform drafting and spinning at a single frame. Alternatively, the spinning may be a Perlok spinning or a converter spinning, in which the fiber is once made as a sliver and twisted to make a spun yarn in two or more steps. The direct spinning is preferred. By using the stretch-broken yarn, the strength can be maintained high, and thus a sheath-core structured spun yarn having excellent conformity with the sheath fiber is obtained.

For a single fiber, the preferred fineness of the stretch-broken spun yarn is in a range of 5.56 to 20.0 tex (a single fiber having a metric count of 50 to 180), and more preferably, 6.67 to 16.7 tex (a single fiber having a metric count of 60 to 150). A stretch-broken spun yarn having a fineness in the range has a high strength and can be applied suitably for heat-resistant protective suit and the like in light of its feeling and the like. It is preferable that the twist number is 350 to 550 time/m or more preferably 400 to 500 time/m for a single yarn having a metric count of 125. When the twist number is in this range, conformity with the covering fiber is improved further. Further, the preferred fiber lengths are distributed in the range of 30 to 220 mm, the average fiber length is in a range of 80 to 120 mm and preferably 90 to 110 mm. With these ranges, the strength can be maintained even higher.

In the present invention, when the fineness and twist number of a single yarn of a stretch-broken spun yarn are indicated respectively as S₀ (tex) and T₀ (time/m), the twist factor Ks₀ of the single yarn is calculated by an equation below.

Ks₀=T₀·√S₀

In a case of representing the spun yarn with a count, the twist factor Kc₀ of the single yarn is calculated by an equation below, where a count of a single yarn and the twist number are indicated respectively as C₀ (m/g) and T₀ (time/m).

Kc₀=T₀/√C₀

(2) Sheath-Core Spun Yarn

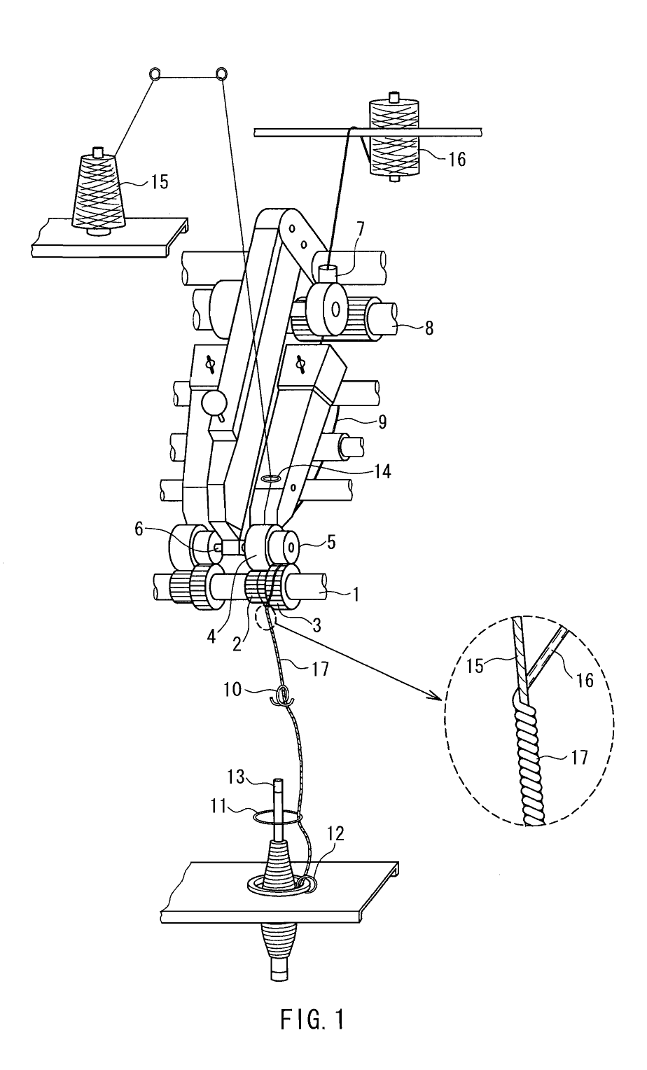

Next, an apparatus and a method for producing a sheath-core structured yarn of the present invention will be explained. FIG. 1 is a perspective view showing main elements of a ring frame in an example of the present invention. For each draft part, a pair of columns 2, 3 different from each other in diameter are provided on a front-bottom roller 1 that is driven to rotate positively. The columns 2, 3 are linked directly and coaxially in the axial direction. On the columns 2, 3, a pair of cylindrical front-top rollers 4, 5 different from each other in diameter are placed. The difference in diameter between the front-top rollers 4, 5 is substantially the same as the difference in diameter between the columns 2, 3 below, but the dimensional relationship is reverse to that of the columns 2, 3 below. The front-top rollers 4, 5 are covered with rubber cots, and fit respectively on a loaded common arbor 6 so as to roll independently. A staple bundle 16 drawn out from a rove bobbin is fed from a guide bar to a back roller 8 through a trumpet feeder 7.

The staple bundle 15 is prepared as a para-aramid stretch-broken fiber bundle for making a core fiber, while the staple bundle 16 is prepared as a covering fiber bungle. Though not shown, the trumpet feeder 7 can be swung in the axial direction of the front-bottom roller 1, and the swing width can be adjusted. A staple bundle B that has been delivered from the back roller 8 and passed through the draft apron 9 is spun out in a state being held by the large-diameter column 3 and the small-diameter cylindrical front-top roller 5. A staple bundle A is fed through the yarn guide 14 to the small-diameter column 2 and the large-diameter cylindrical front-top roller 4, and then spun out.

The delivery speed of the staple bundle 16 spun out from the large-diameter column 3 is greater than the spinning speed of the staple bundle 15 spun out from the small-diameter column 2. Therefore, when the two spun staple bundles 15, 16 are twisted through a snail wire 10, the staple bundle 16 is entangled around the staple bundle 15, thereby a sheath-core type multilayer-structured spun yarn 17 is formed, with the staple bundle 15 as the core and the staple bundle 16 as the sheath.

It is preferable that the overfeeding rate of the staple bundle 16 to the staple bundle 15 is 5 to 9%, and more preferably 6 to 8%. When the overfeeding rate is within the above-mentioned range, the staple bundle 16 can wrap up the staple bundle 15 at a substantially 100% cover rate.

The spun yarn 17 is wound up by a yarn pipe 13 on the draft part through an anti-node ring 11 and a traveler 12. Even when there is a variation in the positions to hold the staple bundles 15, 16 on the columns 2, 3 depending on the draft parts, since the delivery speed ratio between them is always constant, there is no possibility that the property of the produced sheath-core structured spun yarn 17 varies depending on the draft parts. Further, when the trumpet feeder 7 is swung in a possible range in the axial direction of the front-bottom roller 1, the frictional region of the rubber cot cover of the front-top roller 5 to be rubbed against the staple bundle 16 is dispersed to prevent early abrasion of the rubber cot cover. Though not shown, it is preferable that the yarn guide 14 is swung in the axial direction of the front-bottom roller 1 so as to decrease the abrasion of the rubber cot cover on the cylindrical front-top roller 4.

A preferred twist direction for a single yarn of a sheath-core spun yarn is the same as that of a single yarn of a stretch-broken yarn, and, the most preferred twist number Tₘₐₓ (time/m) is decided by the fineness S₀ (tex) and the twist number T₀ (time/m) of the stretch-broken spun yarn irrespective of the single yarn fineness after covering with the sheath fiber, and thus the following equation is established.

Tₘₐₓ=Rs·T₀·√S₀

In the equation, when the proportional constant Rs=0.495, the core fiber and the sheath fiber exhibit the optimal conformity such as a bolt-and-nut relationship, and the strength of the single yarn of the sheath-core spun yarn is maximized.

In a case of presenting the single yarn with a count, the most preferred twist number Tₘₐₓ (time/m) is decided by the count C₀ (m/g) and the twist number T₀ (time/m) of the single yarn of the stretch-broken spun yarn, and thus the following equation is established.

Tₘₐₓ=Rc·T₀/√S₀

In the equation, when the proportional constant Rc=15.7, the optimal conformity is exhibited, and the strength of the single yarn of the sheath-core spun yarn is maximized.

The thus obtained sheath-core spun yarn has a core of a yarn of a stretch-broken spun para-aramid fiber and a sheath of polyetherimide fiber (A) and at least one fiber (B) selected from wool and flame-retardant rayon, which covers around the core. Therefore, damage caused by abrasion or the like in the para-aramid fiber yarn can be reduced even after washing and/or the percentage of the para-aramid fiber exposed on the spun yarn surface is lowered, and thus the appearance will not deteriorate even when damage caused by abrasion or the like occurs due to washing. In any way degradation in the quality can be prevented.

5. Two-Fold Yarn

A protective suit fabric of the present invention is formed of a two-fold yarn prepared by twisting (1) a single yarn of uniform blended spun yarn and (2) a single yarn of sheath-core spun yarn having a core of a yarn of a stretch-broken spun para-aramid fiber and a core formed by blend-spinning polyetherimide fiber and wool. A two-fold yarn is used for the warp in a woven fabric of hydrophobic fibers represented by wool, since the two-fold yarn has at least a doubled strength when compared to a single yarn and thereby can provide a conjugative power to prevent yarn breakage during weaving, and irregularity in thickness of the single yarn is compensated to provide a delicate mesh texture to the woven fabric. For example, the two-fold yarn is produced by use of a twister such as a double-twister.

In a woven fabric of a hydrophilic fiber represented by cotton, a sized single yarn is used for the warps. In weaving, the adjacent warps rub each other repeatedly at every shedding motion of the loom, and rotate in a direction to reversely twist every time tensile force is applied. As a result, the surface fuzzes of the warps get entangled. Thus, further fuzzes are drawn out from the yarns so as to degrade the conjunctive power. Finally, the yarn will be broken to stop the loom. If the fiber is hydrophilic, starches or the like easily adhere to the yarn. Since the surface fuzzes are hardened with the sizing agent, the conjugative power will not deteriorate during the weaving, and no breakage of the warps occurs. Furthermore, the thus woven fabric later can be desized easily by washing with water during a refining step.

In contrast, as wool and many kinds of synthetic fibers are hydrophobic, starches or the like do not work efficiently. Even if a special sizing agent could be applied to the yarn surface, at present there has been found no method to desize in an easy and inexpensive manner such as washing in water during the refining step after the weaving.

Warp breakage in a loom depends considerably on the conjugative power regarding the rubbing, entanglement and peeling of the surface fuzzes rather than the strength (cN/deci tex) of the single fiber that forms the yarn. Needless to note, polyester whose single fiber strength is 5 times the wool and also para-aramid whose single fiber strength is 5 times the polyester are also hydrophobic. Therefore, it is preferable that warps of these fibers are prepared as two-fold yarns.

The twist direction (S-twist or Z-twist) and the twist factor K₂ of a two-fold yarn with respect to the twist direction and the twist factor K₁ of a single yarn are set depending on the type of the fabric to be woven. Here, a wool woven fabric will be explained as an example. For obtaining crimpy touch or crispy touch for georgette or voile, with respect to Z-twisted single yarn, the two-fold yarn is also Z-twisted and K₂ is set to be larger so as to make a so-called high twisted yarn. In contrast, in a case of saxony or flannel, it is preferable that the surface of the woven fabric is napped sufficiently to provide softness, bulkiness and shiny smoothness. In such a case, the single yarn is Z-twisted, while the two-fold yarn is S-twisted and its K₂ is set smaller in order to make a so-called loose twisted yarn, thereby promoting felting and raising.

In the present invention, it is preferable that the fineness S₁ of the single yarn of uniform blended spun yarn is in a range of 15.6 to 55.6; the twist factor Ks₁ of the single yarn is in a range of 2560 to 2750; the twist direction of a two-fold yarn formed by twisting the single yarn of the uniform blended spun yarn and the single yarn of the sheath-core spun yarn is opposite to the twist direction of each of the single yarns; and the twist factor Ks₂ of the two-fold yarn is in a range of 3490 to 3760. Here, the twist factor Ks₁ of the single yarn and the twist factor Ks₂ of the two-fold yarn are calculated by equations below.

Ks₁=T₁·√S₁

Ks₂=T₂·√S₂

In the equations, T₁ indicates a twist number (time/m) of the single yarn, T₂ indicates a twist number (time/m) of the two-fold yarn, S₁ indicates a single yarn fineness (tex) and S₂ indicates a two-fold yarn fineness (tex).

In a case of presenting the spun yarn with a count, it is preferable that the count is in a range of 1/18 to 1/64, the twist factor Kc₁ of a single yarn is in a range of 81-87, the two-fold yarn is twisted in a direction opposite to the direction for twisting the single yarn, and the twist factor Kc₂ of the two-fold yarn is in a range of 78-84. Here, the twist factor Kc₁ of the single yarn and the twist factor Kc₂ of the two-fold yarn are calculated by equations below.

Kc₁=T₁/√C₁

Kc₂=T₂/√C₂

In the equations, T₁ indicates a twist number (time/m) of the single yarn, T₂ indicates a twist number (time/m) of the two-fold yarn, and C₁ indicates a single yarn count (m/g).

Table 1 below shows twist directions of the respective yarns, preferred ranges of twist numbers, twist factors and fineness of the single yarn and the two-fold yarn. For reference, the counts are also recited.

TABLE 1

| | Stretch-broken | Sheath-core | Uniform blended | Two-fold |
|---|---|---|---|---|
| | spun yarn | spun yarn | spun yarn | yarn |
| Twist direction | Z | Z | Z | S |
| Twist number | T₀ = 250-605 | Tₘₐₓ = 555-710 | T₁ = 345-695 | T₂ = 330-670 |
| (time/m) | | | | |
| Twist factor | Ks₀ = 1115-1425 | Rs = 0.495 | Ks₁ = 2560-2750 | Ks₂ = 3490-3760 |
| Yarn fineness (tex) | S₀ = 5.56-20.0 | S₁ = 15.6-55.6 | S₁ = 15.6-55.6 | S₂ = 31.2-111.2 |
| Referred twist factor | Kc₀ = 35-45 | Rc = 15.7 | Kc₁ = 81-87 | Kc₂ = 78-84 |
| Referred count (g/m) | C₀ = 1/50-1/80 | C₁ = 1/18^{*1}-64 | C₁ = 1/18^{*1}-64 | C₂ = 2/18^{*2}-64 |

Note 1:
this indicates a single yarn of 1 g in weight per 18 m in length
Note 2:
this indicates a two-fold yarn of 2 g in weight per 18 m in length

When the values of these items are in the above-identified ranges, the twist structure is stable, the yarn conjugative property is high, and thus a woven fabric with a delicate mesh texture and soft feeling can be obtained.

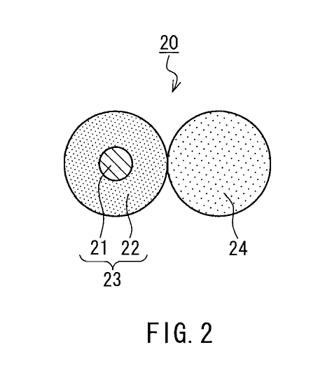

FIG. 2 is a schematic cross-sectional view showing the thus obtained two-fold yarn. A two-fold yarn 20 is composed of a sheath-core structured spun yarn 23 and a uniform blended spun yarn 24. The sheath-core structured spun yarn 23 has a core 21 of a stretch-broken spun yarn made of a para-aramid fiber and a sheath 22 formed by blend-spinning at least one fiber selected from a wool fiber and a flame retardant rayon fiber with a polyetherimide fiber, to which an antistatic fiber is added as required.

The obtained two-fold fiber is subjected to twist-fixing and used as warps and wefts to make a woven fabric. Examples of the woven fabric texture include plain weave, twill weave, satin weave and the like. In a case of knitted fabric texture, any of flat knitting, circular knitting, and warp knitting can be applied. There is no particular limitation on the knitted texture. When air is to be included in the knitted fabric, a double linkage pile fabric is formed.

It is preferable that the weight per unit (metsuke) of the protective suit fabric of the present invention is in a range of 100 to 340 g/m², so that lighter and more comfortable work clothing can be provided. It is more preferable that the range is 140 to 300 g/m², and particularly preferably 180 to 260 g/m².

The protective suit fabric of the present invention experiences no heat shrinkage when exposed for 3 seconds to a heat flux at 80 kW/m²±5% in accordance with ISO 9151 Determination of Heat Transmission on Exposure to Flame, and in a flammability test as specified in JIS L 1091A-4 (vertical method, 1992, flame contact: 12 seconds), its char length is not more than 5 cm in both the longitudinal and horizontal directions. The fabric experiences no or reduced heat shrinkage even if it is exposed to high temperature, and the fabric is flame retardant, so that the comfort in wearing is kept favorable despite wetting from sweat during exertion under a high-temperature and severe environment.

It is preferable that an antistatic fiber further is added to the fabric. This is to inhibit the charging of the fabric when the final product is in use. Examples of the antistatic fiber include a metal fiber, a carbon fiber, a fiber in which metallic particles and carbon particles are mixed, and the like. The antistatic fiber preferably is added in a range of 0.1 to 1 mass % relative to the spun yarn, and more preferably in a range of 0.3 to 0.7 mass %. The antistatic fiber may be added at the time of weaving. For example, 0.1 to 1 mass % of “Beltron” manufactured by KB Seiren Ltd., “Clacabo” manufactured by Kuraray Co., Ltd., a carbon fiber or a metal fiber may be added.

The polyetherimide fibers can be dyed as a fiber, as a yarn or as a fabric. Since the para-aramid fiber is poorly dyed, preferably it is spun-dyed in advance. In this context, spin-dyeing indicates coloring a polymer with a pigment or a coloring agent at a stage prior to the spinning step.

### EXAMPLE

The present invention will be described below in further detail by way of Examples. The measurement method used in the Examples and Comparative Examples of the present invention are as follows.

### (1) Heat Shrinkage Test

Heat shrinkage was measured at the time of exposure for 3 seconds to a heat flux at 80 kW/m²±5% in accordance with ISO 9151 Determination of Heat Transmission on Exposure to Flame.

### (2) Burn Resistance

The char length created by bringing a flame of a Bunsen burner into contact for 12 seconds with the lower end of a woven fabric sample oriented vertically, the afterflame time after the flame was removed, and the afterglow time were measured according to the method specified in JIS L 1091A-4.

### (3) Washing Resistance

The fabric was washed five times in accordance with ISO 6330-1984, 2A-E specified in ISO 11613-1999 as the international performance standards.

### (4) Electrification Voltage Test

The voltage immediately after electrification was measured according to the method for a frictional electrification attenuation measurement specified in JIS L1094 5.4.

### (5) Washing Test for Measurement of Damage to Texture

Measurement was carried out in accordance with JIS L 1096 F-2 (medium temperature washer method).

Washing condition: continuous washing for 300 minutes
Water temperature at washing: 60° C.
Rinsing condition: operating for 5 minutes with water at about 40° C. and subsequently operating for 10 minutes after renewing water (temperature: about 40° C.)
Applied detergent: ECE detergent; use amount: 0.1 mass %
Sample weight: ten samples and a loading cloth, 1.4 kg in total
Drying condition: hang-dry (air-dry)

### (6) Other Physical Properties

The other physical properties were measured in accordance with JIS or the industry standards.

### Example 1

### 1. Applied Fibers

### (1) Polyetherimide Fiber

For a polyetherimide fiber, “Ultem” manufactured by Sabic Innovative Plastics (limiting oxygen index (LOI: 32; a single fiber fineness: 3.3 deci tex (3 deniers) and average fiber length: 89 mm) was used, and the fiber was dyed to olive-green color. A jet dyeing machine manufactured by Nissen Corporation was used as a dyeing machine, and dyes and other additives (Kayaron Polyester Yellow FSL (Nippon Kayaku Co., Ltd.) 3.60% o.w.f., Kayaron Red SSL (Nippon Kayaku Co., Ltd.) 0.36% o.w.f., Kayaron Polyester Blue SSL (Nippon Kayaku Co., Ltd.) 1.24% o.w.f, acetic acid (68 wt %) 0.0036% o.w.f., and sodium acetate 0.0067% o.w.f.) were added, and the dyeing treatment was carried out at 135° C. for 60 minutes.

### (2) Wool Fiber

For the wool fiber, an unmodified merino wool produced in Australia (average fiber length: 75 mm) was used, which was dyed to olive-green color by an ordinary method by using an acid dye.

### (3) Para-Aramid Fiber

For the para-aramid fiber, a stretch-broken spun yarn of “Technora” (trade name) manufactured by Teijin, Ltd., having yarn fineness of 8.0 tex (metric count: 1/125) (single fiber fineness: 1.7 deci tex (1.5 deniers), average fiber length: 100 mm, spun-dyed) was used.

### (4) Antistatic Fiber

For the antistatic fiber, “Beltron” (trade name) manufactured by KB Seiren Ltd., having a single fiber fineness of 5.6 deci tex (5 deniers) and an average fiber length of 89 mm was used.

2. Manufacture of Two-Fold Yarn of Blended Spun Yarn

### (1) Blended Spun Yarn

Materials of yarn-dyed polyetherimide fiber, yarn-dyed wool and an antistatic fiber were introduced separately into a card so as to open the fibers and to make a fibrous web. 59.5 mass % of the polyetherimide fiber, 40 mass % of the wool and 0.5 mass % of the antistatic fiber were blended by using a sliver and subjected to a fore-spinning step and a fine spinning step, thereby a blended spun yarn was obtained.

### (2) Stretch-Broken Sheath-Core Spun Yarn

By the method as shown in FIG. 1, a stretch-broken sheath-core spun yarn having a core of 36.0 mass % of para-aramid fiber (spun-dyed) and having a sheath of blended fiber components of 38.1 mass % of the yarn-dyed polyetherimide fiber, 25.6 mass % of the yarn-dyed wool and 0.3 mass % of the antistatic fiber was manufactured.

### (3) Two-Fold Yarn

The blended spun yarn and the stretch-broken sheath-core spun yarn were twisted with each other by a double-twister so as to make a two-fold yarn. The percentages of the respective fibers in the thus obtained two-fold yarn are: 48.8 mass % of polyetherimide fiber; 18.0 mass % of para-aramid fiber; 32.8 mass % of wool; and 0.4 mass % of antistatic fiber. Table 2 shows the twist directions, the twist numbers, the twist factors and the yarn counts of the respective yarns.

TABLE 2

| | Stretch-broken | Sheath-core | Uniform blended | Two-fold |
|---|---|---|---|---|
| | spun yarn | spun yarn | spun yarn | yarn |
| Twist direction | Z | Z | Z | S |
| Twist number | T₀ = 450 | Tₘₐₓ = 630 | T₁ = 560 | T₂ = 540 |
| (time/m) | | | | |
| Twist factor | Ks₀ = 1273 | Rs = 0.495 | Ks₁ = 2668 | Ks₂ = 3638 |
| Yarn fineness (tex) | S₀ = 8.0 | S₁ = 22.7 | S₁ = 22.7 | S₂ = 45.4 |
| Referred twist factor | Kc₀ = 40 | Rc = 15.7 | Kc₁ = 84 | Kc₂ = 81 |
| Referred count (g/m) | C₀ = 1/125 | C₁ = 1/44 | C₁ = 1/44 | C₂ = 2/44 |

3. Manufacture of Woven Fabric

Using the spun yarns for the warps and the wefts, a woven fabric having a ½ twill weave texture was manufactured with a rapier loom. This woven fabric did not experience any heat shrinkage when exposed for 3 seconds to a heat flux at 80 kW/m²±5% in accordance with ISO 9151 Determination of Heat Transmission on Exposure to Flame, and in a flammability test as specified in JIS L 1091A-4, its char length was not more than 5 cm in both the longitudinal and horizontal directions. The appearance of the woven fabric was favorable after washing for measurement of damage to the texture. The physical properties and the testing methods are shown in Table 3.

TABLE 3

| Test item | | Measured value | | Testing method |
|---|---|---|---|---|
| Unit weight | Normal state | 221.2 | g/m² | JIS L 1096-8.4.2 |
| Pick density | Warp | 242 number/10 cm | | JIS L 1096-8.6.1 |
| | Weft | 226 number/10 cm | | |
| Tensile strength | Warp | 1260N | | JIS L 1096-8.12.1a |
| | Weft | 1090N | | (method A) |
| Tensile elongation | Warp | 19.6% | | JIS L 1096-8.12.1a |
| | Weft | 17.5% | | (method A) |
| Tear strength | Warp | 75.4N | | JIS L 1096-8.15.2 |
| (A-2) | Weft | 70.7N | | (method A-2) |
| Dimensional change | Warp | 0.4% | | JIS L 1096-8.64.4 |
| (method C) | Weft | 0.4% | | (method C) |
| Washing dimensional change | | | | |
| 5 times | Warp | 2.5% | | ISO 11613-1999 |
| 5 times | Weft | 1.8% | | ISO 6330 2A-E |
| 5 times | Appearance | grade 4 | | |
| Appearance after washing test for | | Favorable | | JIS L 1096 F-2 (medium |
| measuring damage to texture | | | | temperature washer method) |
| Heat resistance Shrinkage | Warp | 1.0% | | ISO 11613-1999 Annex A |
| rate | Weft | 0.0% | | |
| Frictional electrification attenuation | | | | |
| Immediately after | Warp | −790 | V | JIS L 1094.5.4 |
| Immediately after | Weft | −370 | V | |
| Heat shrinkage | Warp | No | | exposed to a heat flux |
| | Weft | No | | at 80 kW/m² ± 5% for 3 |
| | | | | seconds in accordance |
| | | | | with ISO 9151 |
| | | | | Determination of Heat |
| | | | | Transmission on |
| | | | | Exposure to Flame |
| Flame resistance | | | | |
| Char length | Warp | 4.7 | cm | ISO 11613-1999 → in |
| Char length | Weft | 4.2 | cm | a case of |
| Afterflame | Warp | 0.0 | sec. | afterflame•afterglow |
| Aflerflame | Weft | 0.0 | sec. | time of 0 second, JIS L |
| Afterglow | Warp | 0.8 | sec. | 1091A-4 alternate |
| Afterglow | Weft | 0.7 | sec. | method (Annex 8), |
| | | | | year of 1992 flame |
| | | | | contact: 12 seconds |
| | | | | (vertical method) |

Ten workers at a chemical facility took part in a one-month wear test of work clothing made of the woven fabric manufactured through the above-mentioned process. The workers at this facility ordinarily wear working cloth made of a material composed of 50 mass % of flame-retardant acrylic fiber and 50 mass % of flame-retardant cotton fiber (hereinafter, referred to as ‘acrylic/cotton’). All of the workers assessed that the comfort of the work clothing for the wear test was superior to that of their conventional work clothing. The grounds for the favorable assessment on the comfort are: the clothing maintains warmth despite perspiration during exertion and it is less chilly; it is not sticky; it is quick-drying; it is wrinkle-resistant; it keeps its shape, and the like. Since the fabric of acrylic/cotton fiber got burned in the ISO 9151 Determination of Heat Transmission on Exposure to Flame, measurement result of the heat shrinkage was not obtained. The flammability according to JIS L 1091A-4 alternate method ((Annex 8), year of 1992 flame contact: 12 seconds (vertical method)) was as follows. Char length for warp: 13.7 cm, char length for weft: 11.4 cm, afterflame time for warp: 0.0 second, afterflame time for weft: 0.0 second, afterglow time for warp: 1.6 seconds, and afterglow time for weft: 1.2 seconds.

### Example 2

Example 2 was carried out similarly to Example 1 except that the blend rates of the fibers were as shown in Table 4. In Table 4, washing test indicates a washing test for measurement of damage to the texture.

TABLE 4

| | | | | | | | | Result | | | |
|---|---|---|---|---|---|---|---|---|---|---|---|
| | Fiber type [mass %] | | | | | | | | Char length | | Appearance |
| Test | PEI | Wool | Para- | Antistatic | Yam condition | | | Heat | [cm] | | after washing |
| No. | Fiber | fiber | aramid | fiber | Count | Shape | Arrangement | shrinkage | Warp | Weft | test |
| 2-1* | 61.5 | 35.0 | 3.0 | 0.5 | 2/44 | X:Y | 1:5 | Yes | 7.0 | 6.3 | Favorable |
| 2-2 | 59.5 | 35.0 | 5.0 | 0.5 | 2/44 | X:Y | 1:3 | No | 4.9 | 4.8 | Favorable |
| 2-3 | 49.0 | 32.5 | 18.0 | 0.5 | 2/44 | X | all | No | 4.7 | 4.2 | Favorable |
| 2-4* | 52.5 | 21.0 | 26.0 | 0.5 | 2/65 | X | all | No | 3.4 | 3.2 | Unfavorable |
| 2-5* | 77.5 | 13.0 | 9.0 | 0.5 | 2/44 | X:Y | 1:1 | Yes | 6.2 | 5.9 | Favorable |
| 2-6* | 38.5 | 52.0 | 9.0 | 0.5 | 2/44 | X:Y | 1:1 | No | 7.8 | 7.3 | Favorable |

(Note 1):
*in Test No. indicates Comparative Example.
(Note 2)
PEI is the abbreviation for polyetherimide.
(Note 3):
Shape-X indicates a two-fold yarn as shown in FIG. 2; and Shape-Y indicates a two-fold yarn composed of two blended spun yarns, which includes no para-aramid fiber.

Table 4 illustrates that the fabrics of the present invention experienced no heat shrinkage, the char length was not more than 5 cm, the heat resistance and the flame retardance were high, and the appearance of the woven fabric after being washed for measurement of damage to the texture was favorable.

In contrast, Comparative Examples each had the following problems.

(1) Test No. 2-1 was not favorable because the content of para-aramid fiber was extremely small and a heat shrinkage occurred, and the char length was great.
(2) Test No. 2-4 was not favorable because the excessive para-aramid fiber obstructed sufficient covering, and thus the color of the spun-dyed fiber became noticeable, and the appearance became comparatively unfavorable after washing.
(3) Test No. 2-5 was not favorable because the excessive polyetherimide caused heat shrinkage, and the char length was great. Moreover, because the content of wool was extremely small, the comfort in wearing was inferior.
(4) Test No. 2-6 containing an extremely large amount of wool was not favorable, since the char length was great.

Supplementary explanations for the above test follow.

(1) From the viewpoint of technical restriction, the limit for the finest count for a stretch-broken yarn of para-aramid fiber is 1/125.
(2) There is no restriction for the thickest count for the stretch-broken yarn of para-aramid fiber. However in a case of joining fine spun yarns, about 1/90 (single yarn having a metric count of 90) is the limit to ensure a safe work without necessity of particular tools or without the risks of severing fingers.
(3) Therefore, in a case of actually using a stretch-broken yarn as a core, the blend rate for the para-aramid fiber cannot be set arbitrarily. Therefore in the test, the blend rate as shown in Table 3 was changed by adapting the yarn arrangement of “two types of two-fold yarn shapes=X&Y”.
(4) As recited in Note 3 below Table 4, Shape-X indicates a two-fold yarn composed of a sheath-core spun yarn and a blended spun yarn, while Shape-Y indicates a two-fold yarn including no sheath-core structured yarn.
(5) For example, in a case of producing a material of test No. 2-1 including 3.0 mass % of para-aramid fiber, a lattice-like woven fabric including X and Y arranged at a ratio of 1:5 in both longitudinal and horizontal directions is provided. In such a case, the weight is 3 mass % or ⅙ in comparison with a case where all of the yarns are X (=all) because in the latter case, the weight will be 18 mass %.
(6) It was possible to blend the PEI fiber and the wool at an arbitrary rate. And thus, woven fabrics of the blend rates as indicated in Table 4 were produced actually to allow assessment on various characteristics through flammability test and the like.
(7) In Test No. 2-4, the single yarn of 1/65 (single yarn having a metric count of 65) of the stretch-broken sheath-core spun yarn was problematic since the sheath was too thin to allow the core to sprawl therefrom, and thus the color of the core fiber was noticeable. And the appearance became significantly unfavorable after washing.

### Example 3

Example 3 was carried out similarly to Example 1 except that the wool was replaced by flame-retardant rayon. For the flame-retardant rayon, “Viscose FR” (trade name) manufactured by Lenzing AG in Austria (average fineness: 3.3 deci tex, average fiber length: 75 mm) was used. Using the two-fold yarns for the warps and the wefts, a woven fabric having a ½ twill weave texture was manufactured with a rapier loom. This woven fabric did not experience any heat shrinkage when exposed for 3 seconds to a heat flux at 80 kW/m²±5% in accordance with ISO 9151 Determination of Heat Transmission on Exposure to Flame, and in a flammability test as specified in JIS L 1091A-4, its char length was not more than 5 cm in both the longitudinal and horizontal directions. The appearance of the woven fabric was favorable after washing for measurement of damage to the texture and the comfort in wearing was also favorable.

### EXPLANATION OF LETTERS AND NUMERALS

1 front-bottom roller
2 large-diameter column
3 small-diameter column
4,5 front-top roller
6 arbor
7 trumpet feeder
8 back roller
9 draft apron
10 snail wire
11 anti-node ring
12 traveler
13 yarn pipe
14 yarn guide
15 staple bundle (para-aramid stretch-broken fiber bundle as core fiber)
16 staple bundle (covering fiber bundle)
17 sheath-core structured spun yarn
20 two-fold yarn
21 core fiber (stretch-broken spun yarn of para-aramid fiber)
22 sheath fiber (covering fiber)
23 sheath-core structured spun yarn
24 uniform blended spun yarn

1. A heat-resistant flame-retardant protective suit fabric formed of a spun yarn of blended fibers comprising: 25 to 75 mass % of polyetherimide fiber (A); 20 to 50 mass % of at least one fiber (B) selected from wool and flame-retardant rayon; and 5 to 25 mass % of para-aramid fiber (C) when the fabric is formed of 100 mass % of fibers,
wherein the spun yarn for forming the fabric is a two-fold yarn prepared by twisting 1) a single yarn of a uniform blended spun yarn comprising the fiber components (A) and (B); and 2) a single yarn of a sheath-core spun yarn comprising a core of a yarn of a stretch-broken para-aramid fiber (C) and a sheath formed by blend-spinning the polyetherimide fiber (A) and the at least one fiber (B) selected from wool and flame-retardant rayon.

2. The protective suit fabric according to claim 1, wherein a twist factor Ks₁ of the single yarn of the uniform blended spun yarn is in a range of 2560-2750, the two-fold yarn is twisted in a direction opposite to the direction for twisting the single yarn, and a twist factor Ks₂ of the two-fold yarn is in a range of 3490 to 3760,
where the twist factor Ks₁ of the single yarn and the twist factor Ks₂ of the two-fold yarn are calculated by equations below:
Ks₁=T₁·√S₁
Ks₂=T₂·√S₂
in the equations, T₁ indicates a twist number (time/m) of the single yarn, T₂ indicates a twist number (time/m) of the two-fold yarn, S₁ indicates a single yarn fineness (tex) and S₂ indicates a two-fold yarn fineness (tex).

3. The protective suit fabric according to claim 1, which experiences no heat shrinkage when exposed to a heat flux at 80 kW/m²±5% for 3 seconds in accordance with ISO 9151 Determination of Heat Transmission on Exposure to Flame and which has a char length of not more than 5 cm in the longitudinal and horizontal directions in the flammability test specified in JIS L 1091A-4.

4. The protective suit fabric according to claim 1, wherein the blended spun yarn further comprises an antistatic fiber.

5. The protective suit fabric according to claim 1, which is either a woven fabric or a knitted fabric.

6. The protective suit fabric according to claim 1, wherein the polyetherimide fiber that forms the protective suit fabric has been dyed as a fiber, as a yarn or as a fabric, and the para-aramid fiber has been spun-dyed.

7. The protective suit fabric according to claim 1, wherein the mass per unit of the protective suit fabric is in a range of 100 to 340 g/m².

8. A heat-resistant flame-retardant spun yarn, comprising fibers at a blend rate of: 25 to 75 mass % of polyetherimide fiber (A); 20 to 50 mass % of at least one fiber (B) selected from wool and flame-retardant rayon; and 5 to 25 mass % of para-aramid fiber (C) when the spun yarn is formed of 100 mass % of fibers, and
the spun yarn is a two-fold yarn prepared by twisting: 1) a single yarn of a uniform blended spun yarn comprising the fiber components (A) and (B); and 2) a single yarn of a sheath-core spun yarn comprising a core of a yarn of a stretch-broken para-aramid fiber (C) and a sheath formed by blend-spinning the polyetherimide fiber (A) and the at least one fiber (B) selected from wool and flame-retardant rayon.

9. The spun yarn according to claim 8, which is formed of a two-fold yarn, and a twist factor Ks₁ of the single yarn is in a range of 2560 to 2750, the two-fold yarn is twisted in a direction opposite to the direction for twisting the single yarn and a twist factor Ks₂ of the two-fold yarn is in a range of 3490 to 3760,
where the twist factor Ks₁ of the single yarn and the twist factor Ks₂ of the two-fold yarn are calculated by equations below:
Ks₁=T₁·√S₁
Ks₂=T₂·√S₂
in the equations, T₁ indicates a twist number (time/m) of the single yarn, T₂ indicates a twist number (time/m) of the two-fold yarn, S₁ indicates a single yarn fineness (tex) and S₂ indicates a two-fold yarn fineness (tex).

10. The spun yarn according to claim 8, wherein the blended spun yarn further comprises an antistatic fiber.

11. The spun yarn according to claim 10, wherein the content of the antistatic fiber is in a range of 0.1 to 1 mass %.
